(19) United States
(12) Patent Application Publication
(10) Pub. No.: US 2007/0276943 A1
(43) Pub. Date: Nov. 29, 2007

(54) Prevention of Cloning Attacks in a DOCSIS Network

(75) Inventors: Kevin A. Marez, San Diego, CA (US); William H. Armbruster, San Diego, CA (US); Richard M. DiBenedetto, San Diego, CA (US); Tim J. Stephens, San Diego, CA (US); Robert M. Stephens-Doll, Jamul, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: GENERAL INSTRUMENT CORPORATION, Horsham, PA (US)

(21) Appl. No.: 11/560,475

(22) Filed: Nov. 16, 2006

Related U.S. Application Data
(60) Provisional application No. 60/782,036, filed on Mar. 14, 2006.

(51) Int. Cl. G06F 15/173; G06F 15/16

(52) U.S. Cl. 709/225; 709/245

(57) ABSTRACT

A system and method are provided for preventing a cloned modem from completing the registration process with a communications network. A cable modem termination system (CMTS) compares the media access control (MAC) address of a modem attempting to register with the network with a list of cable modems that are currently registered. If the MAC address is already contained in the list, the CMTS examines communication characteristics associated with the modem to determine if the device attempting to register is a clone. Additionally, a network monitoring system may be used to monitor the MAC addresses contained in DHCP messages to determine if a modem is potentially a clone.

This application claims the benefit of U.S. Provisional Application No. 60/782,036 filed on Mar. 14, 2006, titled Cloning Attacks On Docsis 1.1 Based Data Network, herein incorporated by reference in its entirety.

### FIELD OF THE INVENTION

This disclosure relates generally to cable modem systems, and more particularly to a system and method for preventing a cloned device from registering with a network.

### BACKGROUND OF THE INVENTION

Cable modems are frequently used to connect personal computers to the Internet and other networks. One attraction to cable modems is the high speed connectivity they provide. When a cable modem is connected to a data-over-cable system (i.e., a system allowing high speed data distribution over cable television networks), the modem goes through a registration process which includes a ranging procedure to determine appropriate transmission parameters for data transfer.

There have been reports regarding the ability to hack cable modems allowing, among other things, theft of service, unauthorized user upgrades of the current service level, and potentially disruptive denial of service attacks. One particular problem of interest is that of cable modem cloning. In general, this problem relates to the ability to replicate a valid modem that is recognized to be participating in a network and use the replica to connect to the network. Oftentimes, a hacker may crack open a legitimate modem and use sophisticated electronic devices to copy the contents of flash memory components from the legitimate modem to make clones.

A clone may be any unit where the duplication of any of the information associated with a legitimate modem allows it to imitate the identity of the legitimate original modem. A clone may be created, for example, by stealing the keys from a legitimate cable modem. For example, under the DOCSIS standard, a permanent key would be the 1024-bit private key associated with the modem. Duplication of this key and the corresponding public key certificate would be enough to authenticate a clone. Additionally, a pirate might purposely register a cable modem under a fraudulent account and then copy the keys into cloned units, which could be sold to other users.

Data Over Cable Interface Specification (DOCSIS) is a known standard defining the communication requirements for a data-over-cable system. DOCSIS was designed with some built-in security features. However, these security features are limited due to basic design decisions and philosophies. For example, the built-in security features have no means of preventing cloned modems from being registered with a network. As such, there is a need for a method and apparatus for detecting and preventing a cloned modem from registering with a network, so as to prevent the foregoing problems with the unauthorized use of cloned modems.

### SUMMARY OF THE INVENTION

Accordingly, the present invention relates to a system and method for detecting and preventing a cloned modem from completing registration with a network.

In accordance with one embodiment, a method is provided for detecting a cloned modem at a cable modem termination system (CMTS). Generally speaking, the CMTS compares the media access control (MAC) address of a modem attempting to register with the network with a list of cable modems that are currently registered with the network. If the MAC address is already contained in the list of cable modems, the CMTS uses communication characteristics associated with the modem to determine whether the device attempting to register is a cloned modem. As explained further below, the timing offset is an indication of the distance between a modem and the CMTS. It may be used to detect a clone by determining whether an original device and a suspected clone having the same MAC address have different timing offsets.

The method includes receiving a ranging request from a cable modem, adding the MAC address of the cable modem to a polling list, determining whether the MAC address is already present in the polling list, and tagging the entry as a suspected clone if the MAC address is already present. If the MAC address is already present in the polling list, the method further includes determining a timing offset associated with the suspected clone and determining whether the difference between the timing offset associated with the suspected clone and the modem having the same address exceeds a predefined threshold. If so, the suspected clone is removed from the polling list.

According to one embodiment, a cable modem termination system (CMTS) for detecting a cloned cable modem is provided. Generally speaking, the CMTS is configured to detect the MAC address of a cable modem during its registration process, determine whether the MAC address is currently registered, and compare communication characteristics of the modem with other currently registered modems to determine if the modem is a clone. The cable modem termination system includes an address comparison unit for comparing the MAC address of a cable modem attempting to register with a list of MAC addresses of one or more modems that are currently registered with the network, and a communication characteristic comparison unit for comparing a communication characteristic associated with the first modem with a communication characteristic of the one or more currently registered modems, wherein the cloned modem is detected based, at least in part, on the MAC address and the communication characteristic.

According to another embodiment, a network management system is provided for detecting a cloned modem. Generally speaking, the network management system is able to detect a clone by examining the MAC address of a cable modem contained in a dynamic host configuration protocol (DHCP) message. The network management system includes a dynamic host configuration protocol server configured to receive a discover message from a cable modem and a DHCP clone detection unit configured to determine whether the MAC address of the cable modem is already registered on the network, wherein if the MAC address has already been registered, the cable modem is marked as a potentially cloned modem.

### BRIEF DESCRIPTION OF THE DRAWINGS

FIG. 1 depicts a standard DOCSIS network.

FIG. 2 depicts a DOCSIS network configured to detect a cloned modem, in accordance with one embodiment of the invention.

FIG. 3 depicts an exemplary flow chart of a clone detection method of the present invention.

FIG. 4 depicts a DOCSIS network configured to detect a cloned modem in accordance with another exemplary embodiment of the present invention.

FIG. 5 depicts an exemplary flow chart of a dynamic host configuration protocol detection method of the present invention.

### DETAILED DESCRIPTION OF THE INVENTION

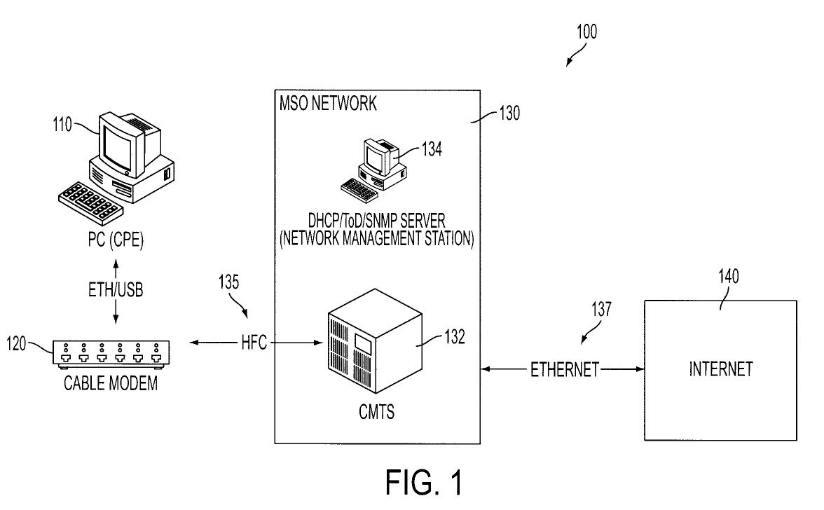

A system and method are provided for detecting and preventing the registration of cloned modems in a network such as, for example, a DOCSIS network. As described above, DOCSIS is a known standard defining the communication requirements for a data-over-cable system. FIG. 1 depicts a standard DOCSIS network 100. DOCSIS network 100 comprises customer premise equipment (CPE) 110, cable modem 120, and multiple system operator (MSO) network 130. Cable modem 120 may be connected to MSO network 130 via a communications link 135 such as, for example, a hybrid fiber coaxial (HFC) communications link. MSO network 130 enables CPE 110 to access external network 140 via communications link 137. It is noted that the foregoing components of the DOCSIS network illustrated in FIG. 1 are known.

MSO network 130 may comprise any cable provider. CPE 110 may be a personal computer or any other device capable of allowing access to an external network. External network 140 may include, for example, a wide area network (WAN), the Internet, or any other external network.

MSO network 130 may be configured to send cable signals to CPE 110 through cable modem 120. MSO network 130 may include cable mode termination system (CMTS) 132 and network management station (NMS) 134, which may be located at the headend or central office associated with the MSO network. In some embodiments, CMTS 132 and NMS 134 may be located in a location remote from the MSO's central office. NMS 134 may include one or more servers configured to provided dynamic host configuration protocol (DHCP), time of day (ToD), simple network management program (SNMP), and/or other services to cable modem 120 as it initializes.

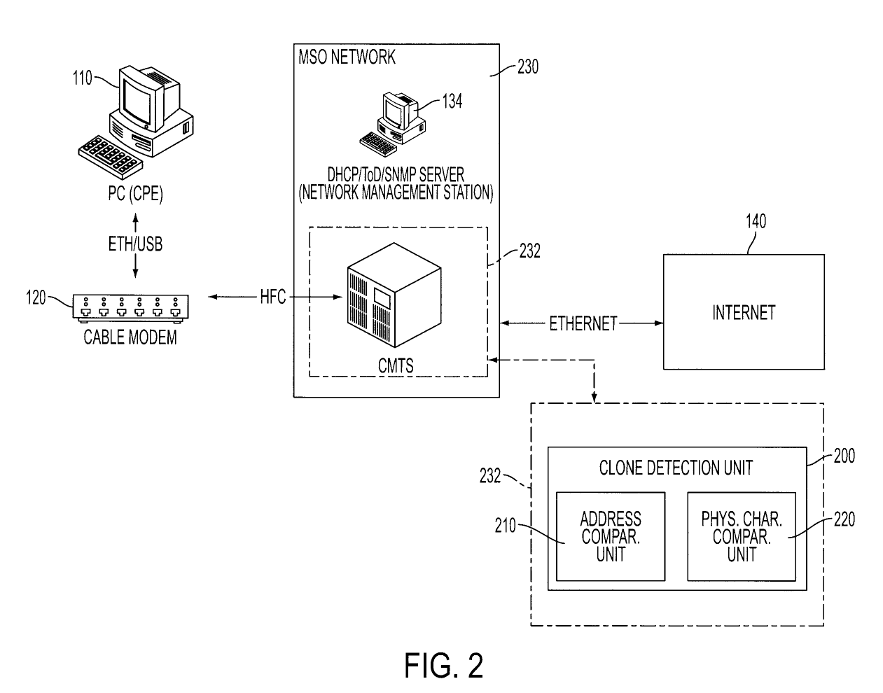

FIG. 2 illustrates an exemplary embodiment of the system of the present invention. As shown, the system is substantially the same as shown in FIG. 1 with the exception that MSO 230 is provided, having CMTS 232. CMTS 232 includes a clone detection unit 200 so as to allow for the detection of a potentially cloned modem during the initialization process. While clone detection unit 200 is depicted as an integral part of CMTS 132, it may be implemented as a separate component. Clone detection unit 200 may be configured to detect a potentially cloned modem by examining the MAC address of each modem attempting to register with the CMTS 232. Clone detection unit 200 comprises an address comparison unit 210 and a communication characteristic comparison unit 220.

More specifically, address comparison unit 210 may be configured to compare the MAC address of a modem attempting to register with the network with a list of MAC addresses for modems that have are currently registered with the network. The list of currently registered modems may be stored, for example, in an internal or external memory device associated with the CMTS. If the modem is attempting to register a MAC address that is currently registered, this may indicate that the modem is a clone, and the system performs the process described below to determine whether or not the modem attempting to register is a clone.

One or more communication characteristics are associated with each cable modem. Each cable modem may have, for example but not limited to, a measured distance from the CMTS, transmission power level, equalization coefficient, and/or other physical attributes. These communication characteristics may be determined by the CMTS during initial and periodic ranging, described below. Communication characteristic comparison unit 220 may be configured to compare one or more communication characteristics of modems having the same MAC address. If the communication characteristics differ by an amount greater than a predefined threshold, this may indicate that the second modem attempting to register utilizing a preexisting MAC address is a clone.

According to an exemplary embodiment, the clone detection process enables a CMTS to detect a potentially cloned modem and prevent the potential clone from completing its registration process. The CMTS compares the MAC address of each modem attempting to register with the network to a list of addresses of modems that are currently registered with the network. The CMTS may also compare the MAC address to a list of approved addresses. If the MAC address of a new modem attempting to register with the network is already in the list of registered modems, or if the address is not on the approved list of addresses, the CMTS marks the modem as a potential clone. The CMTS may also compare physical attributes of the suspected clone with those of the currently registered modem having the same address. If the physical attributes differ by a margin greater than the allowable threshold, the CMTS removes the device from its polling list, preventing it from completing the registration process.

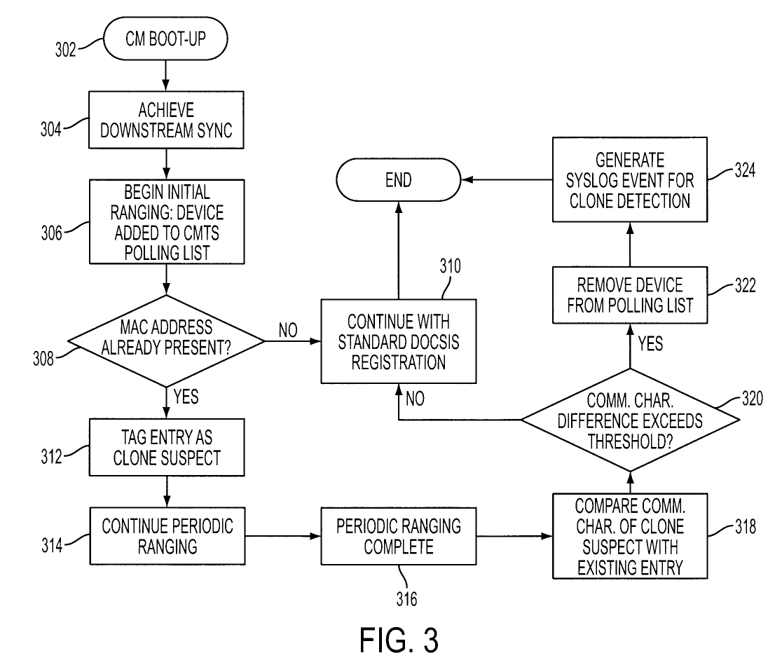

FIG. 3 is an exemplary flowchart illustrating a detection method which may be implemented by the CMTS. As depicted at 302, the process begins when a cable modem boots up. The modem then attempts to achieve downstream synchronization, as depicted at 304. During this process, the modem scans the downstream link searching for digitally modulated signals. Once a digital signal is found, the modem searches for information on that signal that is sent by the system and specifically the CMTS. This information may include, for example, an upstream channel descriptor, which enables the modem to determine, for example, the upstream frequency, modulation type, and channel bandwidth to use in order to communicate with the CMTS.

Once downstream synchronization has been achieved, the modem begins initial ranging, as depicted at 306. Initial ranging is generally performed to configure parameters of the modem such that acceptable communication is set up between the CMTS and the modem. For example, the modem searches for a transmission power level that results in a recognizable response from the CMTS. The CMTS response informs the modem that the selected power level is acceptable or that the modem needs to adjust its power level. Based on the CMTS response, the modem may then continue transmitting at the initial power level or adjust its power level. After an acceptable power level is reached, the initial ranging procedure ends.

During the initial ranging process, the CMTS adds the modem to its polling list. Each cable modem has its own media access control (MAC) address. When a new cable modem is installed, its MAC address is registered with the CMTS and added to its polling list. Polling enables communications to be maintained between the modem and the CMTS, including enabling periodic ranging to be performed. The MAC address further serves to distinguish data sent from individual modems to the CMTS.

In accordance with the current embodiment, the CMTS also performs a check to determine whether the MAC address of the modem is already present in the CMTS's polling list, as depicted at 308. If the MAC address is not already in the polling list, the standard DOCSIS registration protocol continues, as depicted at 310. If the MAC address is already present, the new entry may be placed in the polling list and tagged as a suspected clone, as depicted at 312.

The suspected clone modem and the CMTS continue with periodic ranging, as depicted at 314, until it is complete, as depicted at 316. Periodic ranging is performed to determine whether the modem continues to transmit within acceptable parameters. If the parameters are unacceptable, the cable modem adjusts its parameters during the periodic ranging procedure. This enables the cable modem to continue communications with the CMTS until it is confirmed whether or not the modem is a clone.

During the periodic ranging process, the clone detection unit 200 operates to determine if the modem in question is a clone. During ranging, the modem and the CMTS perform a series of handshakes, and the CMTS determines communication characteristics associated with the modem. As depicted at 318, the CMTS may compare a communication characteristic associated with the suspected clone modem with that of the pre-existing modem entry. The communication characteristics may include, for example, a timing offset, a distance from the CMTS, a transmission power level, equalization coefficients, and/or other characteristics. Using this communication characteristic, the clone detection unit 200 may determine whether there is a difference between the communication characteristic of the suspected clone and the original modem having the identical MAC address.

Specifically, an acceptable communication characteristic threshold may be set and utilized as the criteria to determine whether or not the tagged modem is a clone. As depicted at 320, the clone detection unit 200 determines whether the difference in the communication characteristic between the suspected clone modem and its clone master is within the acceptable threshold limit. If the communication characteristic does not exceed the threshold, the suspected clone modem may continue its standard DOSCIS registration process, as depicted at 310.

However, if the communication characteristic does exceed the threshold, the suspected cloned modem is identified as a clone, and removed from the polling list, as depicted at 322. Removing the device from the polling list prevents the device from maintaining future communication with the CMTS. A SYSLOG event may be generated, as depicted at 324.

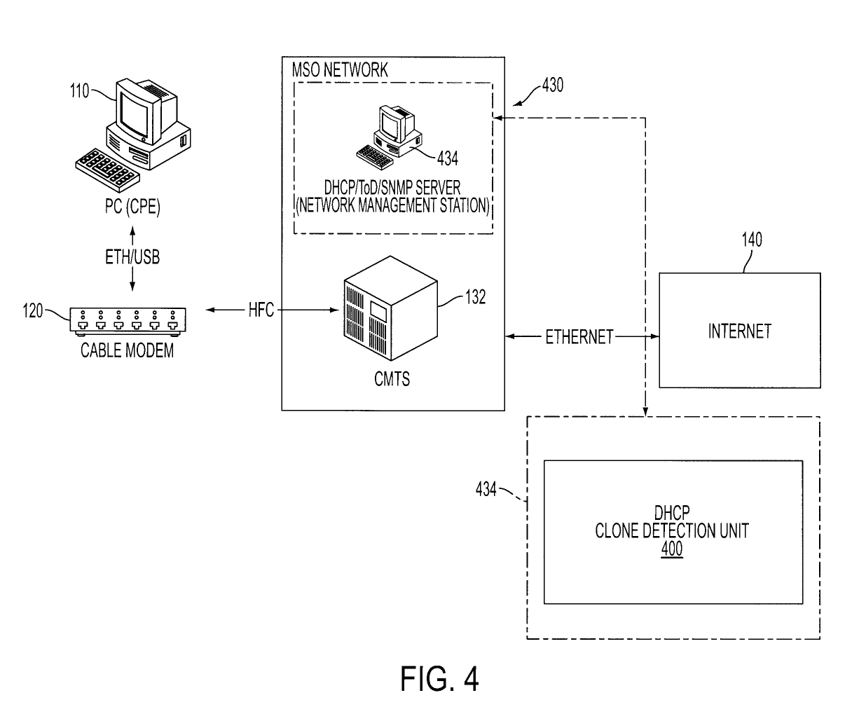

In a second embodiment, a network management station (NMS) may be configured to detect and prevent the registration of a suspected clone modem. FIG. 4 illustrates a block diagram of the system of this embodiment the present invention. As shown, the system is substantially the same as shown in FIG. 1 with the exception that the NMS 434 includes a DHCP clone detection unit 400. DHCP clone detection unit 400 may be configured to compare the MAC address of a modem attempting to register with the network with a list of MAC addresses that have registered with the network. DHCP clone detection unit 400 enables the detection of a clone across multiple cable modem termination systems.

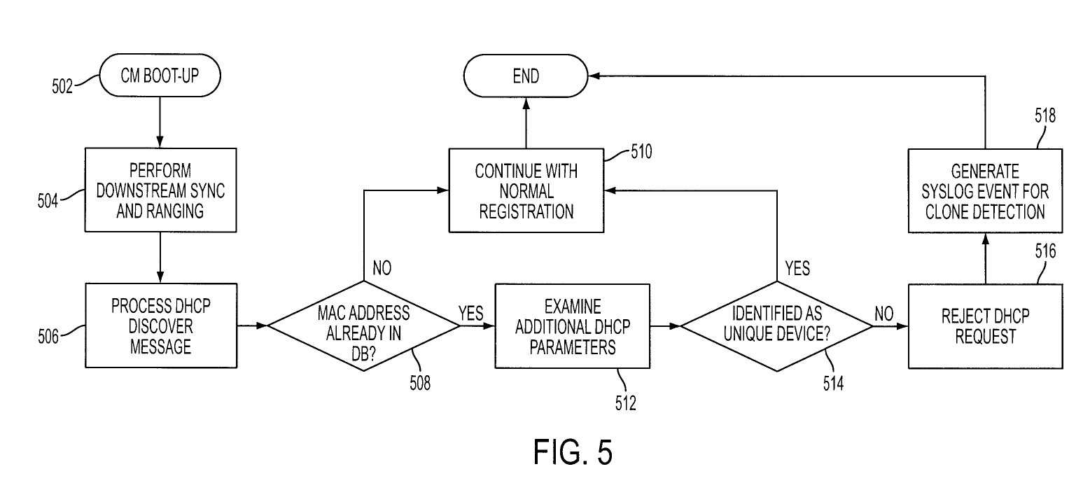

FIG. 5 depicts a detection method in accordance with the second embodiment. As illustrated at 502, 504, the cable modem boots up and performs downstream synchronization and ranging as described above in reference to FIG. 3.

After ranging is complete, the cable modem transmits a DHCP discover message to the NMS, as depicted at 506. The DHCP discover message is a request by the cable modem to obtain an IP address. Additionally, the cable modem may request a configuration file, the IP address of a Time-of-Day (TOD) server, the IP address of a SYSLOG server, and/or other configuration information. The DHCP server associated with the NMS processes the discover message.

In accordance with this embodiment, the NMS determines whether the MAC address of the cable modem whose DHCP discover message has been transmitted is already located in the polling list of one or more CMTSs associated with the NMS, as depicted at 508. The NMS may maintain a database of MAC addresses for each cable modem submitting a DHCP discover message. The NMS may query the database each time it receives a DHCP discover message.

If no duplicate entry is found, the normal registration process continues, as depicted at 510. However, if a duplicate entry is found, the NMS examines additional DHCP parameters, as depicted at 512. For example, the NMS may examine the vendor identification number, model number, bootfile name, and/or the TFTP address included in the DHCP parameters. Upon review of the DHCP parameters, the NMS makes a determination as to whether the cable modem is a unique device, as depicted at 514. If any of the parameters are different from the currently stored DHCP parameters, then the device can be flagged as a clone.

If the NMS determines that the cable modem is a unique device, the registration process continues, as depicted at 510. If the cable modem is not determined to be a unique device, the NMS may reject the DHCP request and generate a SYSLOG event, as depicted at 516, 518.

The processes in FIGS. 3 and 5 may be implemented in hard wired devices, firmware or software running in a processor. A processing unit for a software or firmware implementation may include a controller, a microcontroller, or both of them in communication with each other. Instructions to perform any of the processes illustrated in FIGS. 3 and 5 may be contained on a computer readable medium which may be read by a microprocessor. A computer readable medium may be any medium capable of carrying instructions to be performed by a microprocessor, including a CD disc, DVD disc, magnetic or optical disc, tape, silicon based removable or non-removable memory, packetized or non-packetized wireline or wireless transmission signals.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, while the invention has been described herein in terms of a DOCSIS cable network, the clone detection system and method may also apply to other cable networks as well as non-cable networks such as DSL or telephone networks. Thus, the present invention is not intended to be limited to the embodiments shown herein, but is to be accorded the full scope consistent with the claims.

What is claimed is:

1. An apparatus for detecting a cloned modem, comprising:
an address comparison unit configured to compare a media access control (MAC) address of a new modem attempting to register with a network with a list of MAC addresses of one of more modems that are currently registered with the network,
wherein the cloned modem is detected based, at least in part, on the MAC address.

2. The apparatus of claim 1, wherein the address comparison unit is configured to mark the new modem as a potential clone if the MAC address of the new modem matches the MAC address of one of the currently registered modems.

3. The apparatus of claim 1, further comprising:
a communication characteristic comparison unit for comparing one or more communication characteristics associated with the new modem with one or more communication characteristics of the currently registered modems,
wherein the cloned modem is detected based, at least in part, on at least one of the one or more communication characteristics.

4. The apparatus of claim 3, wherein the one or more communication characteristics comprise at least one of a timing offset and an equalization coefficient.

5. The apparatus of claim 3, wherein the communication characteristic comparison unit is configured to:
compare the communication characteristics associated with the new modem and the communication characteristics associated with a currently registered modem having the same MAC address as the new modem;
determine whether the difference between the communication characteristics exceed a predefined threshold; and
remove the new modem from the polling list if the difference exceeds the predefined threshold, indicating that the new modem is a clone.

6. The apparatus of claim 1, further comprising:
a dynamic host configuration protocol (DHCP) server configured to receive a discover message from the new cable modem,
wherein the address comparison unit is configured to determine the MAC address of the new modem by examining the discover message, and
wherein if the MAC address is currently registered, the cable modem is marked as a potentially cloned modem.

7. The apparatus of claim 6,
wherein the address comparison unit is configured to determine whether the MAC address of the new cable modem is currently entered in the polling list of one or more cable modem termination systems.

8. The apparatus of claim 6, further comprising a DHCP clone detection unit, wherein the DHCP clone detection unit is configured to:
examine one or more DHCP parameters associated with the suspected cloned modem to determine if the suspected cloned modem is unique; and
reject the DHCP discover request if the suspected cloned modem is not unique.

9. A method of detecting a cloned modem, comprising the steps of:
receiving a ranging request from a new cable modem;
placing an entry representing the new cable modem in a polling list, the entry including a MAC address associated with the new cable modem;
determining whether the new cable modem is a clone based at least in part on the MAC address.

10. The method of claim 9, further comprising the steps of:
comparing the MAC address of the cable modem with each entry currently entered in the polling list; and
marking the new cable modem as a potential clone if the MAC address of the cable modem is the same as the MAC address of another cable modem currently listed in the polling list.

11. The method of claim 9, wherein if the MAC address of the new cable modem matches the MAC address of another cable modem currently placed in the polling list, the method further comprises the steps of:
determining a communication characteristic associated with the new cable modem;
determining the difference between the communication characteristic of the new cable modem and a communication characteristic associated with the modem having the matching MAC address; and
removing the new cable modem from the polling list if the difference between the communication characteristics exceeds a predetermined threshold.

12. The method of claim 9, further comprising:
receiving a DHCP discover message from a cable modem;
determining whether a MAC address associated with the cable modem is currently registered with a network;
determining whether the cable modem is unique based on one or more DHCP characteristics; and
rejecting the DHCP discover message if the cable modem is not unique, indicating that the cable modem is a clone.

13. The method of claim 12, wherein the polling list includes the MAC address of each cable modem submitting a DHCP discover message to one or more cable modem termination systems.

14. The method of claim 12, wherein determining whether the cable modem is unique comprises:
examining at least one of the one or more DCHP characteristics provided in the DHCP discover message of the new modem,
determining whether the at least one DHCP characteristic of the new modem differs from the corresponding DHCP characteristic associated with a modem in the polling list having the same MAC address.

15. A computer readable medium carrying instructions for a computer to perform a method of detecting a cloned modem, comprising the steps of:
receiving a ranging request from a new cable modem;
placing an entry representing the new cable modem in a polling list, the entry including a MAC address associated with the new cable modem;
determining whether the new cable modem is a clone based at least in part on the MAC address.

16. The computer readable medium of claim 15, wherein the instructions further comprise the steps of:
comparing the MAC address of the cable modem with each entry currently entered in the polling list; and
marking the new cable modem as a potential clone if the MAC address of the cable modem is the same as the MAC address of another cable modem currently listed in the polling list.

17. The computer readable medium of claim 15, wherein the instructions further comprise the steps of:
determining a communication characteristic associated with the new cable modem;
determining the difference between the communication characteristic of the new cable modem and a communication characteristic associated with the modem having the matching MAC address; and
removing the new cable modem from the polling list if the difference between the communication characteristics exceeds a predetermined threshold.

18. The computer readable medium of claim 15, wherein the instructions further comprise the steps of:
receiving a DHCP discover message from a cable modem;
determining whether a MAC address associated with the cable modem is currently registered with a network;
determining whether the cable modem is unique based on one or more DHCP characteristics; and
rejecting the DHCP discover message if the cable modem is not unique, indicating that the cable modem is a clone.

19. The computer readable medium of claim 18, wherein the polling list includes the MAC address of each cable modem submitting a DHCP discover message to one or more cable modem termination systems.

20. The computer readable medium of claim 18, wherein the instructions further comprise the steps of:
examining at least one of the one or more DCHP characteristics provided in the DHCP discover message of the new modem,
determining whether the at least one DHCP characteristic of the new modem differs from the corresponding DHCP characteristic associated with a modem in the polling list having the same MAC address.
